(19) United States
(12) Patent Application Publication
(10) Pub. No.: US 2013/0242810 A1
(43) Pub. Date: Sep. 19, 2013

(54) USING A FULL DUPLEX VOICE PROFILE OF A SHORT RANGE COMMUNICATION PROTOCOL TO PROVIDE DIGITAL DATA

(71) Applicant: AIRBIQUITY INC., Seattle, WA (US)

(72) Inventor: Darrin Garrett, Seattle, WA (US)

(73) Assignee: AIRBIQUITY INC., Seattle, WA (US)

(21) Appl. No.: 13/797,133

(22) Filed: Mar. 12, 2013

Related U.S. Application Data
(60) Provisional application No. 61/610,245, filed on Mar. 13, 2012.

(51) Int. Cl. H04L 5/14

(52) U.S. Cl. CPC H04L 5/14
USPC 370/277

(57) ABSTRACT

In an example, a processing device of an electronic device is configured to determine whether to provide digital data (other than encoded voice) of the first electronic device to a resource of a second electronic device. The processing device is configured to, in response to determining to provide the digital data of the first electronic device to the resource, establish a connection with the second electronic device over an external interface of the electronic device using a first full duplex voice profile of a short range communication protocol. The processing device is configured to convert the digital data into audio information and transmit the audio information over the established connection.

### PRIORITY

This application claims benefit of U.S. Provisional Application No. 61/610,245 filed on Mar. 13, 2012, entitled: USING A BLUETOOTH HEADSET CONNECTION TO SEND FULL DUPLEX MODULATED DATA, which is herein incorporated by reference in its entirety.

### COPYRIGHT NOTICE

© 2012-2013 Airbiquity, Inc. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### BACKGROUND OF THE INVENTION

It is known that a first electronic device that has a short range communication capability, e.g. Bluetooth capability, USB capability, or the like, but which may not have a long range communication capability, e.g. may not have cellular transceiver, may couple to a second electronic device that does have long range communication capability, e.g. a cellular phone, using a short range connection to use the long range transceiver to communicate with a third electronic device that is remote from the first and second electronic devices. Also, more generally the first electronic device may couple to a second electronic device via the short range connection to access a resource of the second electronic device, whether that resource is a long range communication capability or another resource of the second electronic device. The disclosure that follows improves upon the aforementioned arrangements.

### SUMMARY OF THE INVENTION

The following is a summary of the invention in order to provide a basic understanding of some aspects of the invention. This summary is not intended to identify key/critical elements of the invention or to delineate the scope of the invention. Its sole purpose is to present some concepts of the invention in a simplified form as a prelude to the more detailed description that is presented later.

In one example, in preparation to transmitting digital data (other than encoded voice), a processing device of a first electronic device causes the first electronic device to couple to a second electronic device using a short range protocol. The short range protocol is associated with a plurality of profiles including a first full duplex voice profile for communicating encoded voice and a second data profile for communicating digital data (other than voice). Although the short range protocol is associated with the second profile for communicating digital data (other than voice), the processing device does not attempt to establish the connection using the second data profile. Instead, the processing device uses the first full duplex voice profile (which may be a Bluetooth Headset Profile (HSP) in one example) to establish the connection. The Bluetooth Headset Profile is designed for two-way communication of encoded voice. The processing device coverts the digital data into audio information and transmits the same over the established connection for data communication. We use the term “data communication” to mean communicating digital data other than encoded voice.

The first electronic device described above can provide digital data to a resource of an electronic device that does not have the hardware accruements necessary for establishing a Bluetooth connection using the second data profile. For example, some electronic devices do not have the additional layer of hardware required for transmitting digital data (other than encoded voice) over Bluetooth. Such additional layer may include a security chip that is manufactured with an encrypted key and other components to interact with the security chip such as a particularly configured microprocessor to communicate with that security chip and/or manage data communications to and from its host electronic device.

Furthermore, the first electronic device does not need to have such additional layer of hardware (regardless of whether or not an electronic device with which the first electronic device establishes the connection does or does not have such additional layer of hardware). This can be an advantage when considering manufacturing costs including the costs of components of the additional layer of hardware and other costs such as hardware validation and/or certification expenses associated with using the components in a design of the first electronic device.

Additional aspects and advantages of this invention will be apparent from the following detailed description of preferred embodiments, which proceeds with reference to the accompanying drawings.

### BRIEF DESCRIPTION OF THE DRAWINGS

FIG. 1 is a flowchart illustrating a method for transmitting digital data over a short range connection between devices.

FIG. 2 is a flowchart illustrating a method for receiving over a short range connection between devices.

FIG. 3 illustrates one example of data transmission path of application data of a first electronic device.

FIG. 4 illustrates one example of a system for using a Bluetooth Headset Profile (HSP) connection to send full duplex modulated data.

FIG. 5 illustrates one example of a system for using a full duplex voice profile of Bluetooth to provide data from a first electronic device to a second electronic device for in-band transmission over a wireless telecommunication network to a third remote electronic device.

### DETAILED DESCRIPTION OF PREFERRED EMBODIMENTS

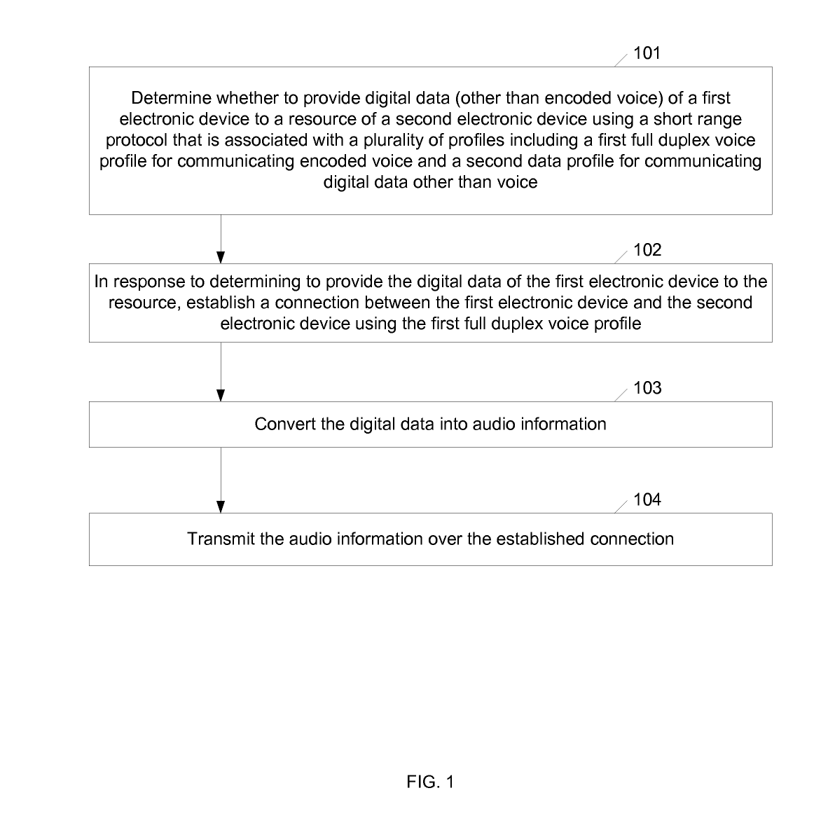

FIG. 1 is a flowchart illustrating a method for transmitting digital data over a short range connection between devices.

In block 101, the processing device determines whether to provide digital data (other than encoded voice) of the first electronic device to a second electronic device using a short range protocol that is associated with a plurality of profiles including a first full duplex voice profile for communicating encoded voice and a second data profile for communicating digital data (other than voice). In an example, the short range protocol is Bluetooth. In an example, the first full duplex voice profile comprises the Bluetooth Headset Profile (HSP).

In block 102, in response to determining to provide the digital data of the first electronic device to the resource, the processing device establishes a connection between the first electronic device and the second electronic device using the first full duplex voice profile. The resource may comprise a long range transceiver, a GPS transceiver, an accelerometer, a processor, persistent storage, or the like.

In block 103, the processing device converts the digital data into audio information. The modulation may be by done in hardware or in software. In an example, the modulator may implement known “in-band signaling” techniques. In block 104, the processing device transmits the audio information over the established connection.

In an example, by using the Bluetooth headset connection with the second electronic device as a data communication channel, the first electronic device can communicate with an application residing on the second electronic device without the need for additional hardware and software communication interfaces. Thus, the existing headset communication, which was originally meant for voice communication, can be used for data communication.

The data communication may use the audio channel of the Bluetooth headset connection between the first electronic device and the second electronic device to send modulated data to the second electronic device and receive modulated data from the second electronic device. This modulation can be in any form where digital data is transitioned into audio information. Once the second electronic device receives the audio it is converted back into its digital format which can then be understood and consumed by the application layer software.

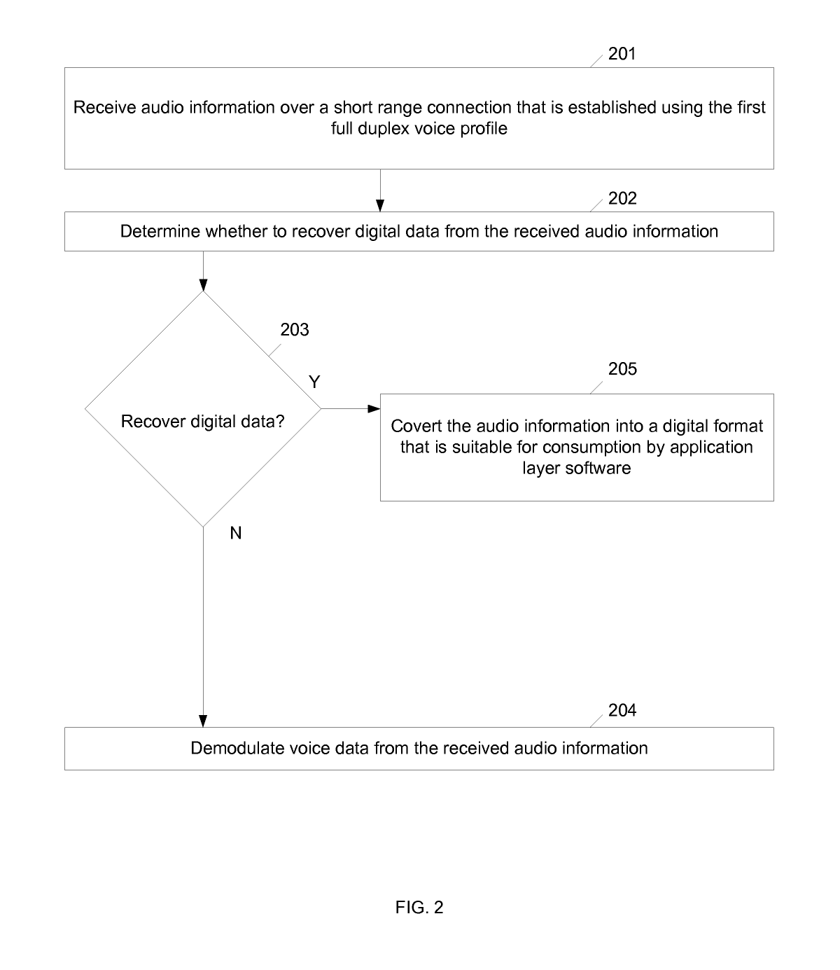

FIG. 2 is a flowchart illustrating a method for receiving over a short range connection between devices.

In block 201, the processing device receives audio information over a short range connection that that is established with the second electronic device using the first full duplex voice profile.

In block 202, the processing device determines whether to recover digital data from the received audio information. If the processing device determines to not recover digital data from the received audio information in diamond 203, then in block 204 the processing device recovers voice data from the received audio information. If the processing device determines to recover digital data from the received audio information in diamond 203, then in block 205 the processing device demodulates the audio information into a digital format that is suitable for consumption by application layer software.

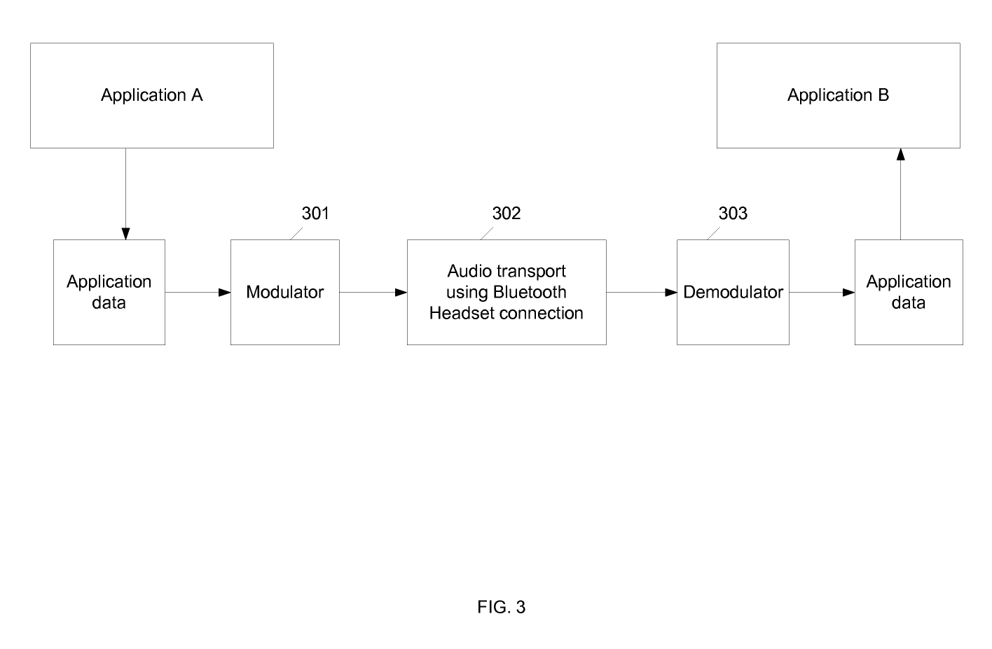

FIG. 3 illustrates one example of data transmission path of application data of a first electronic device.

The application A is of a first electronic device, e.g. an embedded device, and the application B is of a second electronic device, e.g. a cellular phone. The first electronic device provides the application data from application A to a modulator 301. The modulator 301 outputs audio information based on the input application data. The output audio information is transmitted to the second electronic device over the audio transport using a Bluetooth Headset connection.

The second electronic device provides the received output audio information to demodulator 303 to recover the application data. The application B may consume the recovered application data.

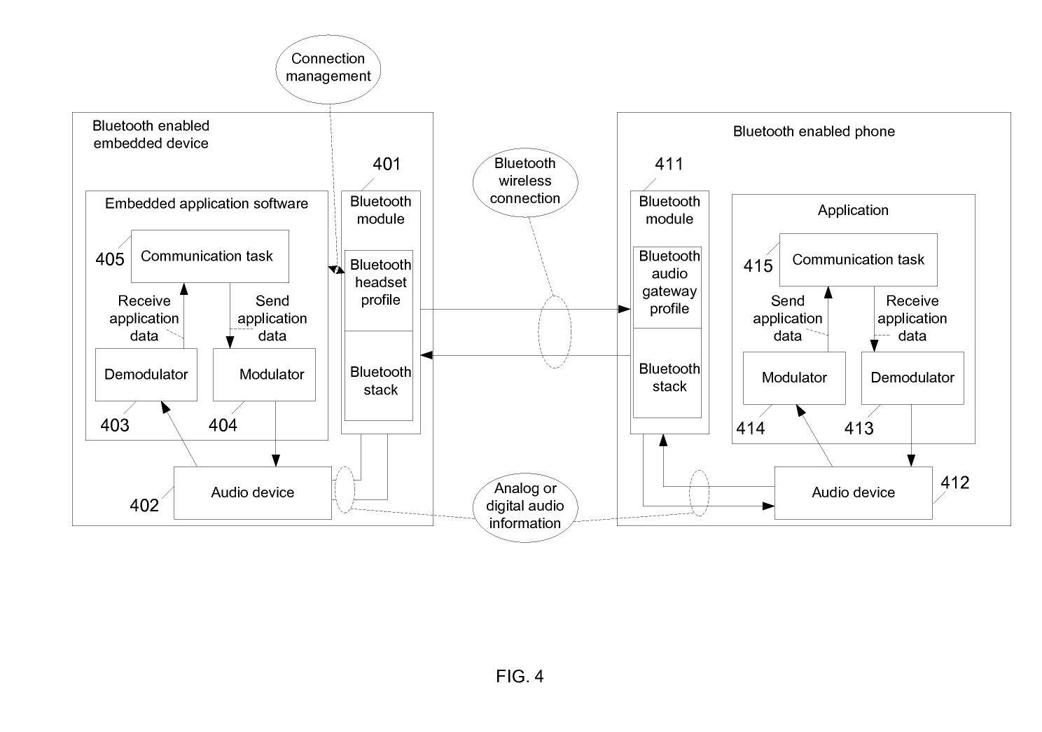

FIG. 4 illustrates one example of a system for using a Bluetooth Headset Profile (HSP) connection to send full duplex modulated data from an embedded device to a cellular phone.

Each of the embedded device and the cellular phone may comprise application layer software running any use case that requires application messages to be exchanged with a peer. The Bluetooth module 401 may contain Bluetooth radio hardware, Bluetooth stack firmware, and the Bluetooth headset profile. The Bluetooth module 411 may contain Bluetooth radio hardware, Bluetooth stack firmware, and the Bluetooth audio gateway profile.

The audio devices 402 and 412 may each be responsible for interfacing with the Bluetooth module's audio interface and providing a digital encoded PCM stream to and from their associated application.

The software modulators 404 and 414 and the software demodulators 403 and 413 may be configured to process the digital audio information to and from application layer data.

Each of the communication tasks 405 and 415 that reside in the application layer on the embedded device and the cellular phone are responsible for the communication of application layer messages to its peer communication task.

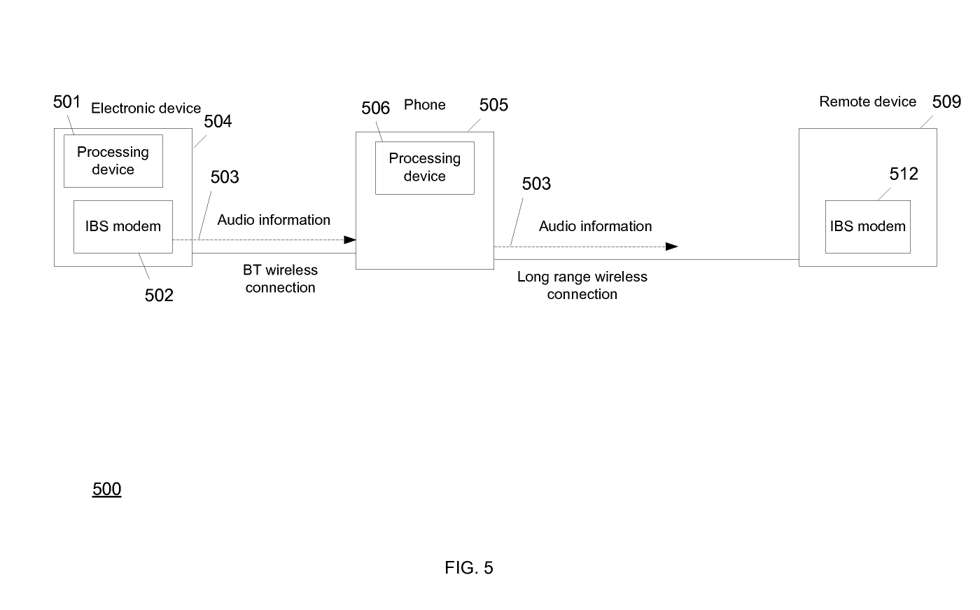

FIG. 5 illustrates one example of a system for using a full duplex voice profile of Bluetooth to provide data from a first electronic device to a second electronic device for in-band transmission over a wireless telecommunication network to a third remote electronic device.

In the example system 500, the electronic device 504 may comprise an In-Band Signaling (IBS) modem 502. A processing device 501 may determine whether to use the IBS modem 502 of the electronic device 504 for a transmission to a peer device such as phone 505. The determination may be based on whether the phone 505 is configured to use in-band signaling for data transmissions over the wireless telecommunications network. In response to determining that the phone 505 is configured to use the in-band signaling, the processing device 501 may select the IBS modem 502 and generate the audio information 503.

The processing device 506 may determine whether the received audio information 503 comprises in-band signaling. In response to determining that the received audio information does not comprise in-band signaling, the processing device 506 may demodulate the received audio information using a demodulator prior to transmitting a representation of the received audio information using, for example, a packet data connection transceiver. In response to determining the received audio information 503 does comprise in-band signaling, the processing device 506 may bypass demodulation and pass through the received audio information 503 for transmission of the received audio information 503 over the wireless telecommunications network. In the later case, the remote device 509 receives the audio information 503 and demodulates the same using the IBS modem 512 that corresponds to the IBS modem 502 of the electronic device 501.

Similarly, the processing device 506 may determine whether information received from the remote device 509 via in-band signaling is to be demodulated or passed through. In an example, the processing device 506 may determine whether the information received from the remote device 509 via in-band signaling corresponds to the audio information 503. If the information received from the remote device 509 via in-band signaling does correspond to the audio information 503, then the processing device 506 may bypass demodulation and pass through the information received from the remote device 509 via in-band signaling over the Bluetooth wireless connection.

Most of the equipment discussed above comprises hardware and associated software. For example, the typical navigation device is likely to include one or more processors and software executable on those processors to carry out the operations described. We use the term software herein in its commonly understood sense to refer to programs or routines (subroutines, objects, plug-ins, etc.), as well as data, usable by a machine or processor. As is well known, computer programs generally comprise instructions that are stored in machine-readable or computer-readable storage media. Some embodiments of the present invention may include executable programs or instructions that are stored in machine-readable or computer-readable storage media, such as a digital memory. We do not imply that a “computer” in the conventional sense is required in any particular embodiment. For example, various processors, embedded or otherwise, may be used in equipment such as the components described herein.

Memory for storing software again is well known. In some embodiments, memory associated with a given processor may be stored in the same physical device as the processor (“on-board” memory); for example, RAM or FLASH memory disposed within an integrated circuit microprocessor or the like. In other examples, the memory comprises an independent device, such as an external disk drive, storage array, or portable FLASH key fob. In such cases, the memory becomes “associated” with the digital processor when the two are operatively coupled together, or in communication with each other, for example by an I/O port, network connection, etc. such that the processor can read a file stored on the memory. Associated memory may be “read only” by design (ROM) or by virtue of permission settings, or not. Other examples include but are not limited to WORM, EPROM, EEPROM, FLASH, etc. Those technologies often are implemented in solid state semiconductor devices. Other memories may comprise moving parts, such as a conventional rotating disk drive. All such memories are “machine readable” or “computer-readable” and may be used to store executable instructions for implementing the functions described herein.

A “software product” refers to a memory device in which a series of executable instructions are stored in a machine-readable form so that a suitable machine or processor, with appropriate access to the software product, can execute the instructions to carry out a process implemented by the instructions. Software products are sometimes used to distribute software. Any type of machine-readable memory, including without limitation those summarized above, may be used to make a software product. That said, it is also known that software can be distributed via electronic transmission (“download”), in which case there typically will be a corresponding software product at the transmitting end of the transmission, or the receiving end, or both.

Having described and illustrated the principles of the invention in a preferred embodiment thereof, it should be apparent that the invention may be modified in arrangement and detail without departing from such principles. We claim all modifications and variations coming within the spirit and scope of the following claims.

1. An electronic device, comprising:
an interface for communicating externally using a short range communication protocol that is associated with a plurality of profiles including a first full duplex voice profile for communicating encoded voice and a second data profile for communicating digital data other than encoded voice; and
a processing device coupled to the interface, wherein the processing device is configured to:
determine whether to provide digital data (other than encoded voice) of the first electronic device to a resource of a second electronic device;
in response to determining to provide the digital data of the first electronic device to the resource, establish a connection with the second electronic device over the interface using the first full duplex voice profile;
convert the digital data into audio information; and
transmit the audio information over the established connection.

2. The electronic device of claim 1, wherein the processing device is further configured to:
after transmitting the audio information over the established connection, receive new audio information from the second electronic device over the interface using the first full duplex voice profile; and
responsive to receiving the new audio information, recover new digital data from the received new audio information.

3. The electronic device of claim 2, wherein the short range communication profile comprises Bluetooth and the plurality of profiles comprises a plurality of Bluetooth profiles.

4. The electronic device of claim 3, wherein the first full duplex voice profile comprises the Bluetooth Headset Profile (HSP).

5. The electronic device of claim 4, wherein the second electronic device comprises a cellular phone.

6. The electronic device of claim 5, wherein the resource comprise a cellular transceiver of the cellular telephone.

7. The electronic device of claim 4, wherein the resource comprises at least one of a persistent storage component, a GPS transceiver, an accelerometer, and a microprocessor.

8. The electronic device of claim 1, wherein the first full duplex voice profile comprises an audio gateway profile.

9. The electronic device of claim 1, wherein the audio information comprises a digital encoded PCM stream.

10. The electronic device of claim 1, wherein the processing device is further configured to convert the digital data into audio information using an in-band modem in response to determining to provide the digital data of the first electronic device to the resource.

11. A memory device having instructions stored thereon that, in response to execution by a processing device, cause the processing device to perform operations comprising:
receiving audio information over a short range connection that is established between a first electronic device and a second electronic device;
determining whether to recover digital data from the received audio information;
in response to determining to not recover digital data from the received audio information, recovering voice data from the received audio information; and
in response to determining to recover digital data from the received audio information, demodulating the audio information into a digital format that is suitable for consumption by application layer software.

12. The memory device of claim 11, wherein the received audio information is received over an audio channel of the established connection, and wherein the established connection comprises a Bluetooth headset connection.

13. The memory device of claim 12, wherein the Bluetooth headset connection is established using the Bluetooth Headset Profile (HSP).

14. A system, comprising:
a first electronic device having a first interface to couple to a second interface of a second electronic device using a short range communication protocol that is associated with a plurality of profiles including a first full duplex voice profile for communicating encoded voice and a second data profile for communicating digital data other than encoded voice;
wherein the first electronic device comprising a first memory device having instructions stored thereon that, in response to execution by a first processing device, cause the first processing device to perform first operations comprising:
determining whether to provide digital data (other than encoded voice) of the first electronic device to a resource of the second electronic device;
in response to determining to provide the digital data of the first electronic device to the resource, establishing a connection with the second electronic device from the first interface using the first full duplex voice profile;
converting the digital data into audio information; and
transmitting the audio information over the established connection; and
wherein the second electronic device comprises a second memory device having instructions stored thereon that, in response to execution by a second processing device, cause the second processing device to perform second operations comprising:
receiving audio information via the second interface;
determining whether to recover digital data from the received audio information;
in response to determining to not recover digital data from the received audio information, recovering voice data from the received audio information; and
in response to determining to recover digital data from the received audio information, demodulating the audio information into a digital format that is suitable for consumption by application layer software.

15. The system of claim 14, wherein the received audio information is received over an audio channel of the established connection, and wherein the established connection comprises a Bluetooth headset connection.

16. The system of claim 15, wherein the Bluetooth headset connection is established using the Bluetooth Headset Profile (HSP).

17. The system of claim 14, wherein the first operations further comprise:
after transmitting the audio information over the established connection, receiving new audio information from the second electronic device over the first interface using the first full duplex voice profile; and
responsive to receiving the new audio information, recovering new digital data from the received new audio information.

18. The system of claim 17, wherein the short range communication profile comprises Bluetooth and the plurality of profiles comprises a plurality of Bluetooth profiles.

19. The system of claim 18, wherein the first full duplex voice profile comprises the Bluetooth Headset Profile (HSP).

20. The system of claim 19, wherein the second electronic device comprises a cellular phone, and wherein the resource comprise a cellular transceiver of the cellular telephone, and wherein the second operations further comprise:
responsive to demodulating the audio information into the digital format that is suitable for consumption by application layer software, using the cellular transceiver to transmit information to a third electronic device that is remote from the first and second electronic devices.
